(19) United States
(12) Patent Application Publication
(10) Pub. No.: US 2014/0207682 A1
(43) Pub. Date: Jul. 24, 2014

(54) SYSTEMS AND METHODS FOR CONTACTLESS TRANSACTION PROCESSING

(71) Applicant: SecureKey Technologies Inc., Toronto (CA)

(72) Inventors: Greg Wolfond, Toronto (CA); Troy Ronda, Toronto (CA); Andre Boysen, Huntsville (CA); Michael Varley, Toronto (CA); Abhishek Das, Mississauga (CA)

(73) Assignee: SecureKey Technologies Inc., Toronto (CA)

(21) Appl. No.: 14/220,488

(22) Filed: Mar. 20, 2014

Related U.S. Application Data
(63) Continuation of application No. PCT/CA2012/000866, filed on Sep. 21, 2012.
(60) Provisional application No. 61/538,036, filed on Sep. 22, 2011.

(51) Int. Cl. G06Q 20/32

(52) U.S. Cl. CPC G06Q 20/3278
USPC 705/44

(57) ABSTRACT

Systems and methods for performing mobile commerce transactions using mobile devices. A transaction initiation request is received at a transaction server from a merchant device. The transaction server generates a transaction identifier, which is transmitted to the merchant device. The merchant device communicates the transaction identifier to a customer device. The customer device transmits the transaction identifier to the transaction server and authorizes the transaction with the transaction server.

### CROSS-REFERENCE TO RELATED APPLICATIONS

This application is a continuation of PCT International Application No. PCT/CA2012/000866, filed Sep. 21, 2012, which claims the benefit of U.S. Provisional Patent Application No. 61/538,036, filed Sep. 22, 2011. The entire contents of PCT International Application No. PCT/CA2012/000866 and U.S. Provisional Patent Application No. 61/538,036 are hereby incorporated by reference.

### FIELD

The embodiments described herein relate to systems and methods for performing payment transactions using mobile devices. In particular, the described embodiments relate to the use of a proximity communication interface of a customer mobile device and a merchant mobile device to perform payment transactions in a secure manner.

### INTRODUCTION

Contactless or proximity payment methods are increasingly seen as a way for credit card issuers to penetrate the cash payment market. Such payment methods have been shown to provide increased customer transaction volume and improve customer retention and loyalty.

There has been an increase in the number of contactless or proximity payment products such as Barclays QuickTap™, Google Wallet™ and more recently, the PayPal™ Mobile NFC payment solution. This may be related to the increasing inclusion of, and support for, Near Field Communication (NFC) readers in mobile devices, such as smartphones.

### DRAWINGS

For a better understanding of the various embodiments described herein, and to show more clearly how they may be carried into effect, reference will now be made, by way of example only, to the accompanying drawings which show at least one exemplary embodiment, and in which:

FIG. 1 is schematic block diagram of an exemplary transaction system;

FIG. 2 is an exemplary simplified payment process flow diagram;

FIG. 3 is an exemplary message flow diagram for the transaction process of FIG. 2;

FIG. 4 is another exemplary message flow diagram;

FIGS. 5A to 5G illustrate exemplary embodiments of a user interface for a merchant device and, optionally, a merchant terminal, when performing a transaction process;

FIGS. 6A to 6F illustrate exemplary embodiments of a user interface for a customer device when performing a transaction process;

FIG. 7 is an exemplary proximity communication process flow diagram for using NFC for a merchant device;

FIG. 8 is an exemplary proximity communication process flow diagram using NFC for a customer device;

FIG. 9 is an exemplary simplified process flow diagram for a credential verification transaction;

FIG. 10 is an exemplary message flow diagram for the verification transaction process of FIG. 9;

FIG. 11 is a further exemplary simplified process flow diagram for a credential verification transaction; and

FIG. 12 is an exemplary message flow diagram for the verification transaction process of FIG. 11.

The skilled person in the art will understand that the drawings, described below, are for illustration purposes only. The drawings are not intended to limit the scope of the applicants' teachings in any way. Further, where considered appropriate, reference numerals may be repeated among the figures to indicate corresponding or analogous elements.

### DESCRIPTION OF VARIOUS EMBODIMENTS

The described embodiments enable merchants and customers to perform mobile commerce using mobile devices, such as smartphones, by simply tapping two devices together and taking advantage of NFC capability. Accordingly, transactions can be performed at any location on a one-on-one basis without the requirement for a traditional point-of-sale (POS) terminal. The described embodiments can be integrated into existing business applications and systems, allow customers to perform payments easily and anonymously using their choice of a variety of payment methods both virtual and physical, and provide reliable payment confirmation via a push notification to both the merchant and client.

In particular, the described embodiments provide systems and methods for performing mobile commerce using mobile devices. In a broad aspect, the systems and methods allow customers to make payments (e.g., for purchases) by simply tapping their mobile device (e.g., smartphone) against a merchant's mobile device (e.g., smartphone) or by tapping their credit card against a merchant's mobile device. In some cases, the customer may also use a mobile device to scan a Quick Response (QR) code generated on the merchant's mobile device to complete a transaction. The QR code may comprise or refer to transaction information. In some cases, the customer device or merchant device may first be tapped against one or more NFC tags representing items or stock keeping units (SKU), to include the respective items in the transaction to be completed. This intuitive and simple approach enables faster transactions for merchants, while allowing merchants, acquirers, and payment networks to seamlessly integrate the described systems and methods into their applications and services, such as billing and inventory.

To enhance user experience the described systems and methods are easy for customers to use, while maintaining a high level of security. In particular, elements of the current user checkout experience are retained. For example, customers may be afforded the opportunity to select a card from a digital wallet or to physically tap a card on a mobile device.

Privacy can be maintained by allowing the customer to remain anonymous with respect to the merchant.

In addition, the described systems and methods can be extended to serve as the second-factor in a two-factor authentication scheme. For example, when logging in to an online website (e.g., a bank) the website may require a customer username and password, followed by a card tap on a mobile device, or an internal card selection from a digital wallet, to verify that the user is in actual possession of a card or credential, whether physical or virtual. In some embodiments, the digital wallet may be stored in a cloud based network server, and may be synchronized across various devices belonging to the customer. In some cases, additional card details can be added via a customer device by manually entering card details, or by tapping a physical card to the device to create a digital copy in the wallet.

In a broad aspect, there is provided a method of enabling a transaction between a merchant device and a customer device, the method comprising: receiving a transaction initiation request at a transaction server; generating a transaction identifier and transmitting the transaction identifier to the merchant device; receiving the transaction identifier from the customer device, wherein the transaction identifier has been exchanged via proximity communication with the merchant device; transmitting transaction detail data to the customer device; receiving a transaction authorization from the customer device; and in response to the transaction authorization, completing the transaction.

In another broad aspect, there is provided a transaction server for enabling a transaction between a merchant device and a customer device, the transaction server comprising: a network interface; a memory; and a processor, the processor configured to: receive a transaction initiation request; generate a transaction identifier and transmit the transaction identifier to the merchant device; receive the transaction identifier from the customer device, wherein the transaction identifier has been exchanged via proximity communication with the merchant device; transmit transaction detail data to the customer device; receive a transaction authorization from the customer device; and in response to the transaction authorization, complete the transaction.

In yet another broad aspect, there is provided a system for enabling a transaction, the system comprising: a transaction server configured to: receive a transaction initiation request; generate a transaction identifier; a merchant device configured to: receive the transaction identifier; activate a proximity communication interface to transmit the transaction identifier; a customer device configured to: receive the transaction identifier via the proximity communication interface; transmit the transaction identifier to the transaction server; receive transaction detail data from the transaction server, wherein the transaction detail data is transmitted by the transaction server in response to receiving the transaction identifier from the customer device; request a transaction authorization from a user of the customer device; and in response to receiving the transaction authorization, transmit the transaction authorization to the transaction server to enable the transaction server to complete the transaction.

The proximity communication may comprise near-field communication. The proximity communication may also comprise use of a Quick Response (QR) code.

The transaction identifier may be received by the merchant device in a push notification. The at least one transaction item may be received by the customer device in a push notification.

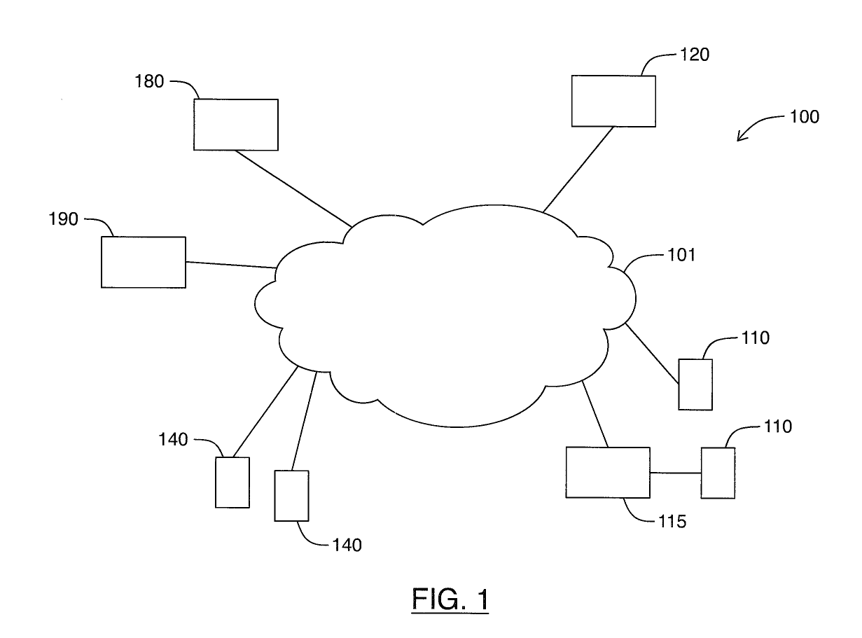

Referring now to FIG. 1, there is shown an exemplary transaction system 100.

Transaction system 100 comprises a network 101, one or more merchant devices 110, a merchant terminal 115, one or more customer devices 140, a transaction server 120 and a push provider server 180.

Network 101 may be a data network such as the Internet and may also comprise various public or private networks, such as 3G, LTE or other wireless data networks, virtual private networks (VPNs) and the like. Merchant devices 110, merchant terminal 115, customer devices 140, transaction server 120 and push provider server 180 can generally be configured to communicate with one or more of each other via network 101. In general, any data exchanged by devices and servers via network 101 may be encrypted using a suitable protocol to provide privacy and security. For example, data communications may use Transport Layer Security (TLS) to encrypt and secure communications.

Merchant device 110 may be a mobile computing device comprising a display, processor, memory and storage for computer program instructions, such as a smartphone, tablet computer, mobile computer or the like. Merchant device 110 can also comprise a wireless or wired network interface, such as an IEEE 802.11 wireless network interface or cellular modem. In some embodiments, merchant device 110 may also comprise a smart card, such as a subscriber identity module (SIM) card. In some embodiments, merchant device 110 may be a dedicated payment processing device, such as a point-of-sale terminal.

Merchant device 110 may be provided with a merchant payment module, which can be an application program stored on merchant device 110. For example, merchant payment module may be a downloadable software application. In another example, merchant payment module may be preprogrammed into merchant device 110 or there may be a dedicated hardware processor module for providing the merchant payment module.

Customer device 140 may also be a mobile computing device comprising a display, processor, memory and storage for computer program instructions, such as a smartphone, tablet computer, mobile computer or the like. Customer device 140 can also comprise a wireless or wired network interface, such as an IEEE 802.11 or “Wi-Fi™” wireless network interface or 3G or UMTS cellular modem. In some embodiments, customer device 140 may also comprise a smart card, such as a subscriber identity module (SIM) card.

Customer device 140 may be provided with a customer payment module, which can be an application program stored on customer device 140. For example, customer payment module may be a downloadable software application. In another example, customer payment module may be preprogrammed into customer device 140 or there may be a dedicated hardware processor module for providing the customer payment module.

Both customer device 140 and merchant device 110 can be equipped with NFC interfaces. NFC comprises a set of short-range wireless technologies, such as ISO/IEC 14443, typically operable at a range of 4 cm or less. Smartphones, such as the Google Nexus S™, now implement NFC technology.

Merchant terminal 115 may be a computing device comprising a display, processor, memory and storage for computer program instructions, such as a tablet computer, mobile computer or desktop computer. Similarly, merchant terminal 115 may comprise a wireless or wired network interface, such as an IEEE 802.11 wireless network interface.

Transaction server 120 may be a network server device comprising a network interface, processor, memory and storage for computer program instructions. The operation of transaction server 120 is described in greater detail herein.

Issuer server 190 may be a network server device comprising a network interface, processor, memory and storage for computer program instructions. Issuer server 190 may be provided by a credit card issuer or acquirer and used to validate and fulfill transactions, such as credit card transactions.

Push provider server 180 may be a network server device comprising a network interface, processor, memory and storage for computer program instructions. Push provider server 180 can be configured to provide push notifications to mobile devices. In some embodiments, the Google™ Cloud to Device Messaging (C2DM) service for Android™ smartphones may be used to provide push provider server 180. The C2DM service is now deprecated by Google™ in favor of the Google™ Cloud Messaging service (GCM). Accordingly, GCM may also be used to provide push provider server 180. The C2DM or GCM service allows push notifications to be sent from a C2DM or GCM server, respectively, to a registered device. In other embodiments, similar or equivalent push notification services, such as the Apple™ Push Notification Service (APNS) for iOS™ or Research In Motion™ BlackBerry® Push Service can also be used.

In general, push provider server 180 acts as the intermediary between transaction server 120 and the merchant device 110 or customer device 140. Transaction server 120 can thus send a notification message destined to a mobile device to push provider server 180, which generates a push notification and transmits the push notification to the relevant mobile device. Push provider server 180 is generally configured to send messages to merchant device 110 or customer device 140 without first being solicited by device 110 or 140 for each message. Accordingly, in some embodiments, push provider server 180 may be a server configured to communicate with merchant device 110 and customer device 140 using a persistent or semi-persistent connection with a stream of messages. One suitable protocol for stream-based communication is the World-Wide Web Consortium (W3C) WebSocket protocol. In such embodiments, “push” notifications can be transmitted to both devices on the socket stream.

In some embodiments, transaction server 120 and push provider server 180 may be integrated into a single server. Correspondingly, the mobile device may be provided with a notification monitoring service, which listens for push notifications from push provider server 180. For example, on an Android™ smartphone, a C2DM or GCM receiver class operates as a service that listens for push messages from the C2DM or GCM server.

There are two exemplary approaches to initiating transaction processing as described herein: mobile device-initiated transactions and web-initiated transactions.

A mobile device-initiated transaction can be used to process payment for one or more items, for example in a retail environment. At checkout, the merchant may use a mobile device, such as merchant device 110, which presents a user interface for directly entering the amount and description of the items to be purchased. In some embodiments, merchant device 110 may provide a speech interface, which allows the merchant to speak these transaction details into the device. Preferably, both the amount and description of the items of to be purchased are mandatory, as it is desirable for the customer to know what they are paying for prior to approving the transaction.

A web-initiated transaction can be used to process payment for one or more items and, in particular, where the merchant may wish to view the order on the display of a device or computer (e.g., when there is a large number of items to be processed such that typing the order using a mobile device interface is less desirable), such as merchant terminal 115, before initiating a proximity payment process. For example, the items to be purchased can be entered on a web form on merchant terminal 115 and subsequently transmitted to the merchant's mobile device (e.g., merchant device 110) for further processing. The web form may be generated by a local web server located on merchant terminal 115, or by a third party web server, such as transaction server 120.

In general, before a transaction takes place, both the customer and merchant devices are preferably registered with transaction server 120. Registration can be used to ensure that transaction information is safely and reliably transmitted only to the customer and merchant devices. In addition, registration allows a log to be maintained of all transactions performed between merchant and customer devices, and also enables push notifications to be sent to both parties. In some alternative embodiments, e-mail notifications may be used in lieu of push notifications.

Information collected during registration may comprise, for example, a description of the device to register and an e-mail address associated with the device or user. For example, to initiate a merchant or customer device, each device may send an HTTP POST request to transaction server 120 containing configuration parameters. In some embodiments, the parameters comprise: a unique device identifier (e.g., MAC address or serial number), a push message identifier (e.g., provided by push provider 180 to uniquely identify the device), a brief description of the device (e.g., a merchant may register his device as “John's Pizza”) and, optionally, an e-mail address associated with the user or device.

Registration need only be performed once, for example when the customer or merchant payment module is installed or initialized.

Transaction server may validate the initialization information and store it for future use. For example, if the C2DM or GCM service is used, transaction server 120 may require a valid Google™ email identifier and password to generate an authorization token to use the C2DM or GCM service to send push notifications. Accordingly, transaction server 120 may transmit a further HTTP POST request comprising the following parameters to obtain an authorization token: a valid Google™ email identifier, password, account type (e.g., “GOOGLE”), application identifier and name of service requesting authorization (e.g., ac2dm).

Once the devices are successfully registered, transaction server 120 may generate a unique identifier for each device and transmit the unique identifier to the device for further use with transaction server 120.

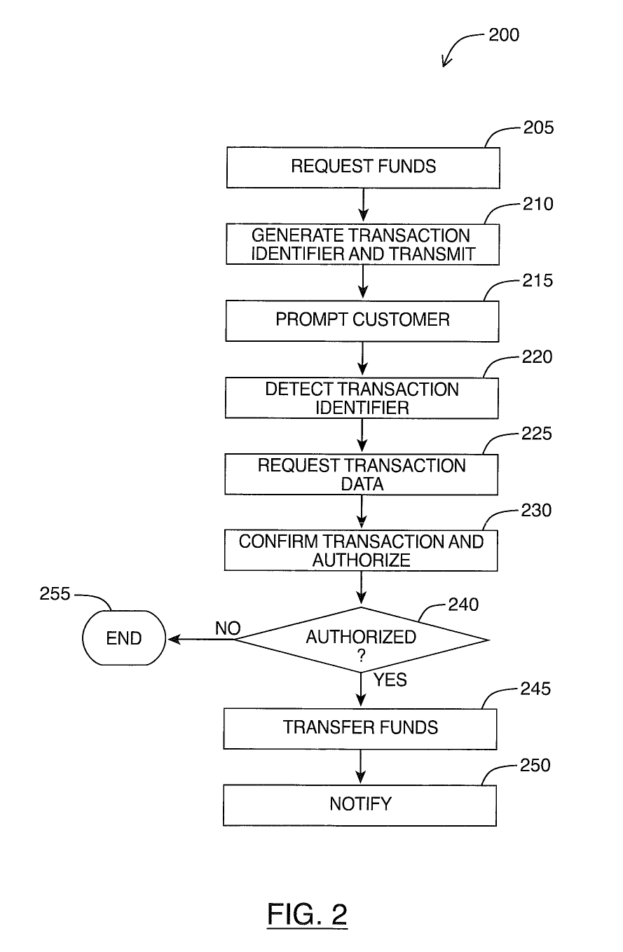

Referring now to FIG. 2, there is shown an exemplary simplified payment process.

A merchant may initiate payment process 200, either using merchant device 110 or merchant terminal 115. After entering and reviewing the details of the transaction, the merchant can initiate the transaction at 205, for example by tapping a “Request Funds” button. In response to the request, merchant device 110 or merchant terminal 115 transmits a transaction initiation request, comprising transaction information such as merchant identifier, transaction amount, transaction description, device location, and the like, from the merchant device or terminal to transaction server 120.

At 210, transaction server 120 receives the transaction initiation request comprising the transaction information and generates a unique transaction identifier, which may also be encrypted. The transaction identifier is transmitted back to the merchant device, along with a transaction URL that can be used by a customer device to obtain further transaction details.

Once the merchant device has received the transaction identifier and transaction URL, the merchant user interface may generate a prompt for the customer to activate the proximity communication method of customer device 140. For example, the user interface may generate and display a prompt for the customer to “tap” the customer device to the merchant device or scan a QR code generated on the merchant's device. It will be appreciated that the proximity communication method may comprise technologies such as NFC, which do not actually require physical contact to exchange information, however the “tap” action is used as an easily understood instruction. Proximity communication may also be referred to as contactless communication.

At 220, the customer complies with the prompt and the proximity communication interface of customer device 140 reads the transaction information (e.g., the transaction identifier and transaction URL) from merchant device 110. In some embodiments, to provide for customer anonymity, only the transaction identifier and, optionally, the transaction URL need be passed from the merchant device to the customer device via the NFC interface.

In some embodiments, customer device 140 may audibly, visually or physical signal that the transaction information has been read (e.g., with a chime, vibration or visual alert). Customer device 140 may launch a customer payment module in response to receiving the transaction information.

At 225, customer device 140 requests further transaction detail data from transaction server 120, for example by using the transaction URL received from merchant device 110. In some embodiments, transaction URL may be omitted and the transaction data request may be based on the transaction identifier itself. Further transaction detail data may comprise information such as requested payment amount, description and merchant description. In some embodiments, the customer may be presented transaction details on a display of customer device 140, for example by tapping a “Review Order” button.

At 230, the customer may confirm the transaction and be prompted to authorize a payment method.

For example, a customer may authorize payment by entering a username and password associated with a digital wallet (which may be stored on customer device 140 or elsewhere on the network). Once the digital wallet is accessed, the customer may be prompted to select a virtual credit card or other security token or credential (e.g., one-time password or cryptogram generator). A SIM/UICC or secure element may also be employed to increase the security of the transaction (e.g., by generating a credit card cryptogram). In some embodiments, credit card information may be stored in the secure element. Customer device 140 may also transmit additional data to help authenticate the user (e.g., a cryptogram or OTP generated on the device, an embedded card, or a card tapped on the reader). Likewise, merchant device 110 may also transmit similar data when connecting to transaction server 120. Such additional data may be sent to transaction server 120 as a form of authentication, which may occur, for example, when the merchant or customer device connects to transaction server 120. Accordingly, transaction server 120 (or optionally issuer 190) can verify the cryptogram and/or tapped or embedded card data to identify the merchant or customer device.

Alternatively, or in addition to the above, the customer may be prompted to tap a physical card (e.g., NFC-enabled credit card) or fob against the customer device NFC reader to complete the transaction.

At 240, customer device 140 determines if the customer provided confirmation and valid authentication to proceed with payment. If confirmation or authentication were not successful, process 200 ends at 255. If confirmation and authentication were successful, customer device 140 transmits a transaction authorization comprising confirmation details (e.g., the card details obtained from the customer by either selecting a stored card or security token from their digital wallet or tapping a card to the mobile device) to transaction server 120, which verifies the details and fulfills payment at 245 using the requested payment method.

If the payment was successful, in response to the transaction authorization, transaction server 120 directly or indirectly sends notifications (e.g., e-mail, push notifications, etc.) to both customer device 140 and merchant device 110, at 250, to complete the transaction.

The merchant can be notified of the amount paid by the customer and whether the payment was accepted or rejected. The customer can be notified of the payment amount, the transaction description, whether or not the payment was accepted or rejected, and in the case where the transaction is accepted, a copy of the transaction record in the form of a digital receipt.

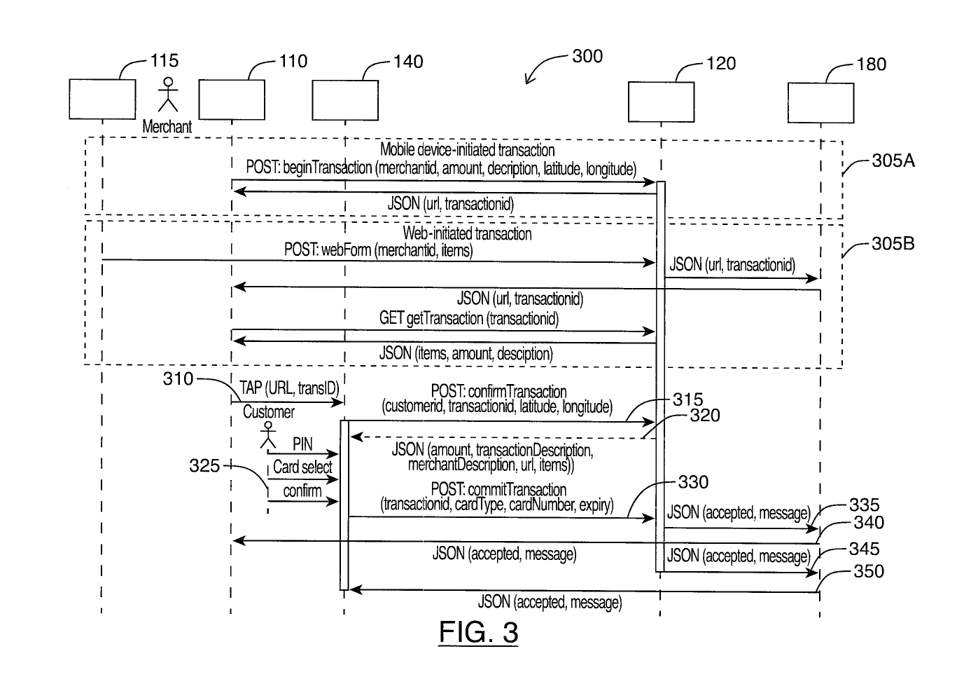

Referring now to FIG. 3, there is shown an exemplary message flow for the transaction process of FIG. 2.

Message flow 300 begins at either 305A or 305B, depending on whether the transaction is mobile device-initiated or web-initiated, respectively.

If the transaction is mobile device-initiated, then merchant device 110 transmits a beginTransaction message to transaction server 120 comprising a merchant identifier, requested amount, description and, optionally, location information (e.g., latitude and longitude).

Transaction server 120 responds to the beginTransaction message by generating and transmitting a transaction identifier and a transaction URL. In some embodiments, responses from transaction server 120, such as the response to the beginTransaction message, may be transmitted using a data interchange format, such as JavaScript Object Notation (JSON). Optionally, the exchanged data structures (e.g., JSON) may be signed for greater security assurance. For example, a JSON signing technology such as JWS (JSON Web Signature) may be used.

In at least one embodiment, merchant device 110 transmits the beginTransaction message in an HTTP POST request to transaction server 120 with one or more of the following parameters: a merchant identifier (e.g., the unique device identifier generated when merchant device registered with transaction server 120), a transaction amount, a transaction description, and a latitude and longitude (e.g., from GPS, Wi-Fi triangulation, or a network-obtained location). As noted above, the beginTransaction message and other messages can be transmitted in encrypted form over a computer network, using an encryption protocol such as TLS.

The response to the beginTransaction message may take the form of a JSON message, such as the following: {“transactionId”:“0c5836483daefd287f7a0e12c81d8939”, “url”:“/androidPush/confirmTransaction.action”}. The message payload may be cryptographically signed and, optionally, encrypted with a shared key usable by the transaction server and merchant device 110.

The transaction identifier and transaction URL may be used as the transaction information that is transmitted from merchant device 110 to customer device 140 via NFC.

Alternatively, if the transaction is web-initiated, then a user may generate a request at merchant terminal 115, for example using a web form in a web browser and transmit a webForm message to transaction server 120 comprising the merchant identifier and a list of one or more transaction items.

Transaction server 120 may generate and transmit a transaction identifier and transaction URL to push provider 180, which may push the transaction identifier and transaction URL to merchant device 110. In some embodiments, both messages may use a data interchange format such as JSON.

Upon receiving the response message, merchant device 110 may request the transaction items from transaction server 120 using the transaction identifier. Transaction server 120 can then respond accordingly with a list of transaction items, amounts and descriptions.

In some embodiments, when a user initiates a transaction via a web interface, transaction server 120 transmits the transaction identifier and transaction URL as a JSON object to push provider 180, which may be a C2DM or GCM server, which generates a push notification comprising the transaction identifier and transaction URL and transmits the push notification to merchant device 110. The push notification may be encrypted.

The push notification may take a similar form to the response to the beginTransaction message, for example:
{“transactionId”:“0c5836483daefd287f7a0e12c81d8939”, “url”:“/androidPush/confirmTransaction.action”}.

Once the push notification is received, merchant device 110 may send an HTTP GET request to transaction server 120 to obtain the list of items the merchant entered via the web interface. In the example embodiment, the only parameter is the transaction identifier obtained from the push notification.

Accordingly, transaction server may respond to the GET request with a further JSON object, such as the following:
{“amount”:83.19, “items”:[{“quantity”:3,“productName”:“Product #5”,“subtotal”:12.27}, {“quantity”:3,“productName”:“Product #4”,“subtotal”:10.44}, {“quantity”:4,“productName”:“Product #3”,“subtotal”:25.52}, {“quantity”:1,“productName”:“Product #2”,“subtotal”:7.33}, {“quantity”:3,“productName”:“Product #1”,“subtotal”:27.63}], “description”:null}.

Described herein are several exemplary JSON objects, which are shown for exemplary purposes only. In other embodiments, the request and response format and data fields may differ depending on specific needs.). Optionally, the exchanged data structures (e.g., JSON) may be signed to enhance security. For example, the JSON objects may be signed with a JSON signing technology such as JWS (JSON Web Signature).

As shown, JSON arrays may be used for describing a plurality of items.

At 310, a customer device 140 and merchant device 110 activate a NFC exchange, for example by tapping one device to the other. Merchant device 110 transmits transaction information to customer device 140. Transaction information may comprise a transaction identifier and a transaction URL.

In some embodiments, merchant device 110 creates a JSON object comprising the transaction identifier and transaction URL and writes it as a NFC Data Exchange Format (NDEF) record to the NFC interface (e.g., “NFC Tag”) in merchant device 110. An example JSON NDEF written to the NFC Tag may take the following form:
{“requestType”:“NFC_TRANSFER”,“transactionId”:“0c5836483daefd287f7a 0e12c81d8939”,“url”:“/androidPush/confirmTransaction.action”}

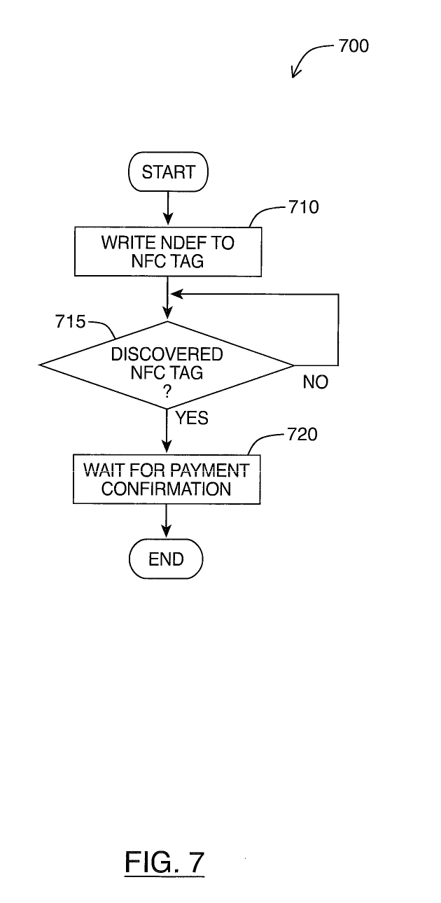

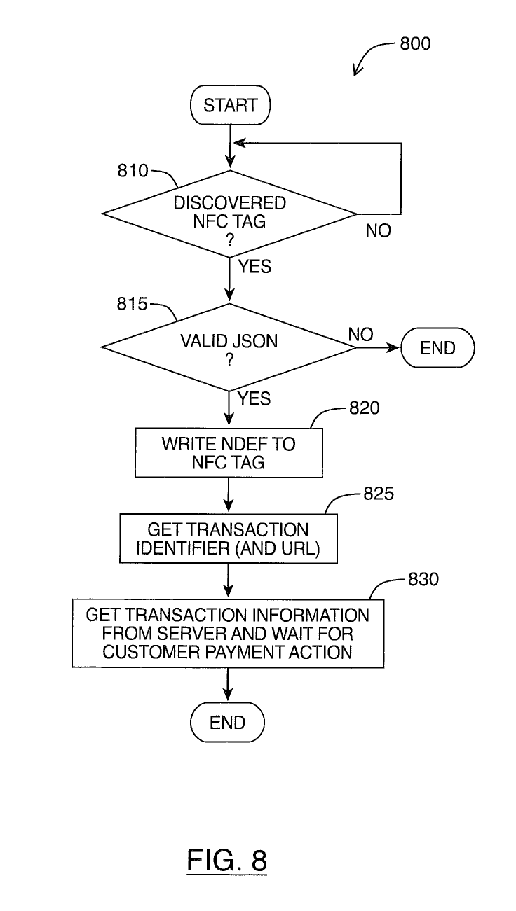

Accordingly, when customer device 140 is within range (e.g., less than 4 cm away) or tapped to merchant device 110, a customer payment module may be automatically initiated. For example, on an Android™ device, payment may be initiated by using the NFC Tag and “NDEF Discovered Intent” filter provided by the customer device 140 (e.g., Android service). Exemplary NFC workflows are described in greater detail with reference to FIGS. 7 and 8.

The customer payment module can ensure that the received data is in the required JSON format and can parse the JSON data to obtain the transaction identifier and transaction URL.

At 315, customer device 140 transmits an HTTP POST request to transaction server 120. The HTTP POST request may be directed to the transaction URL received from merchant device 110, and may comprise information such as the unique identifier associated with customer device 140 (e.g., obtained during registration), the transaction identifier received from merchant device 110 and, optionally, location information.

In some cases, transaction server 120 may use the location information provided by customer device 140 to compare with location information obtained from merchant device 110 in relation to the same transaction (i.e., identified by the same transaction identifier). If the device locations are not within a predetermined distance of each other (allowing for some margin of error), then transaction server 120 may halt the transaction as an attempted or suspected fraud.

In some embodiments, the HTTP POST request sent to transaction server 120 may be sent as a JSON object. In the case of web-initiated transactions, a transaction description field may be null, while the items field may have a list of one or more items from the web form.

In the case of a mobile device-initiated transaction, the JSON object may take the following form:
{“amount”:3.19, “transactionDescription”:“2 waters”, “merchantDescription”:“John's Pizza”, “url”:“/androidPush/commitTransaction.action”, “items”:[null]}

The customer device 140 may present a “review order” display to the user on a display of the device. The display may provide a merchant description, transaction amount and transaction description (or item list).

At 320, transaction server 120 transmits a response to customer device 140. The response may comprise a transaction amount, transaction description, merchant description, item list, transaction URL, and the like.

At 325, the customer is prompted to confirm the transaction and authenticate a payment method, as noted above. For example, the customer may be requested to provide a PIN to open a digital wallet. In some embodiments, the digital wallet may be a data structure comprising credit card information, such as card type, number, and expiration date, and may be encrypted and stored securely in a Secure Element.

In some cases, the customer may be requested to provide an external form of payment (e.g., physical credit card). In such cases, customer device 140 may provide a card reader that contains “parsers” for reading various types of credit cards.

Once the customer has provided a valid payment method, for example by selecting a card (or other security token) from their digital wallet or “tapping” a card to their mobile device, a commitTransaction message can be sent in an HTTP POST request to transaction server 120 at 330.

The commitTransaction message may comprise parameters such as the transaction identifier, a credit card type, a credit card number and a credit card expiry date.

Transaction server 120 may then process the transaction with a credit card issuer, such as issuer 190, using the transaction identifier to associate the payment amounts with the payment method details.

Upon completing the issuer transaction, transaction server 120 determines whether the transaction was accepted or rejected. Transaction server can then generate a message for merchant device 110 containing the outcome of the transaction and transmit the message to push provider 180 at 335. In response, push provider 180 generates a push notification comprising the outcome of the transaction and transmits the outcome message to merchant device 110 at 340. Similarly, the transaction outcome message for customer device 140 can be generated and transmitted to push provider 180 at 345 and pushed to customer device 140 at 350.

In some alternate embodiments (not shown), the credit card data collected by customer device 140, either from a physical tap or from a pre-stored virtual card, may be sent directly to the credit card issuer via a secure channel. The issuer may then verify the payment details and transmit push messages (via push provider 180) directly to merchant device 110 and customer device 140 with the status of the payment transaction and a message. Customer device 140 may also transmit additional data to help authenticate the user (e.g., a cryptogram or OTP generated on the device). Likewise, merchant device 110 may also transmit additional data when connecting to transaction server 120.

An example of a confirmation message sent to merchant device 110 may be a JSON object comprising the following data: {“accepted”:true, “message”:“Amount: $12.00”}.

In some alternate embodiments, payment confirmation can be transmitted to the merchant and customer in e-mail messages, using the respective e-mail addresses provided by the customer and merchant at the time of registration.

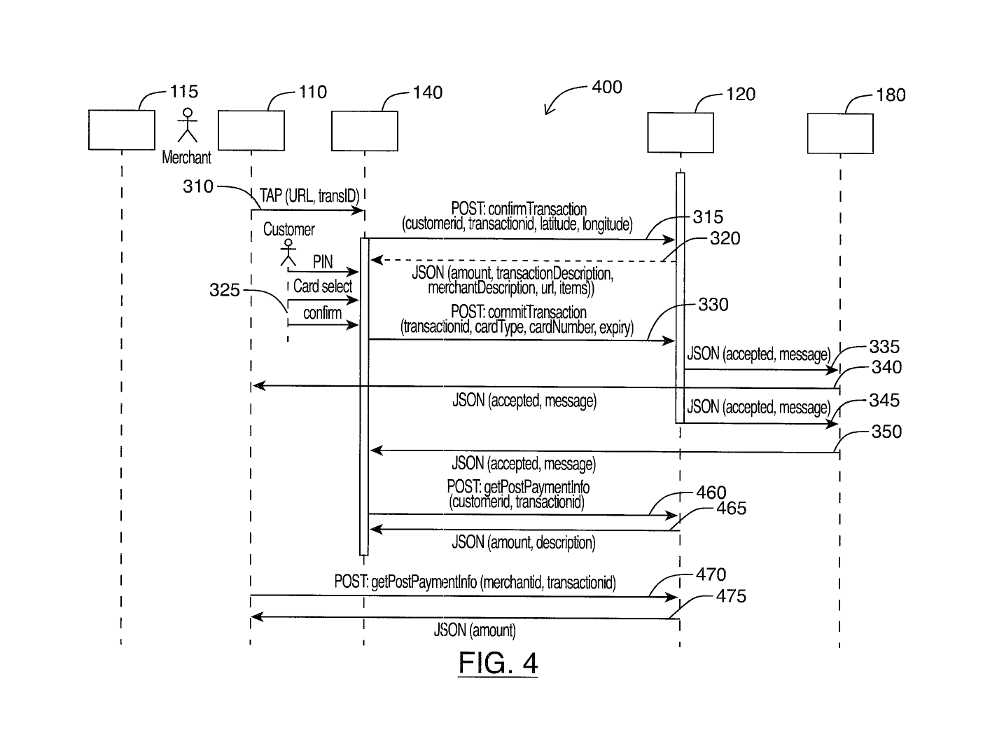

Referring now to FIG. 4, there is shown another exemplary transaction process flow. Process flow 400 is generally analogous to process flow 300, except that the transaction status can be first pushed to merchant device 110 and customer device 140 and subsequently a transaction amount and status of payment can be confirmed.

Accordingly, at 460, customer device 140 may transmit a getPostPaymentInfo request to transaction server 120 in an HTTP POST request. The getPostPaymentInfo request may comprise parameters such as the customer device identifier and transaction identifier. In response, transaction server 120 may transmit a response message at 465 comprising the transaction amount and description.

Similarly, at 470, merchant device 110 may transmit a getPostPaymentInfo request to transaction server 120 in an HTTP POST request. The getPostPaymentInfo request may likewise comprise parameters such as the merchant device identifier and transaction identifier. In response to the merchant device request, transaction server 120 may transmit a response message at 475 comprising the transaction amount.

In some embodiments, once the confirmation of the transaction amount is received, merchant device 110 or customer device 140, or both, may display a confirmation message on a display of the device comprising transaction information, such as the transaction amount. The merchant device confirmation message may also indicate other information, such as a confirmation that the customer device has also received the transaction information.

It will be appreciated that data communications between transaction server 120 and merchant device 110, customer device 140 and push provider 180 are preferably encrypted using, for example, the HTTPS protocol. In general, any communications involving sensitive or private data are preferably encrypted.

In some embodiments, cryptographic signatures may also be included in data communications to provide additional verifiability and security. Likewise, devices may attempt to verify certificate and server validity when communicating with transaction server 120 or other devices or servers.

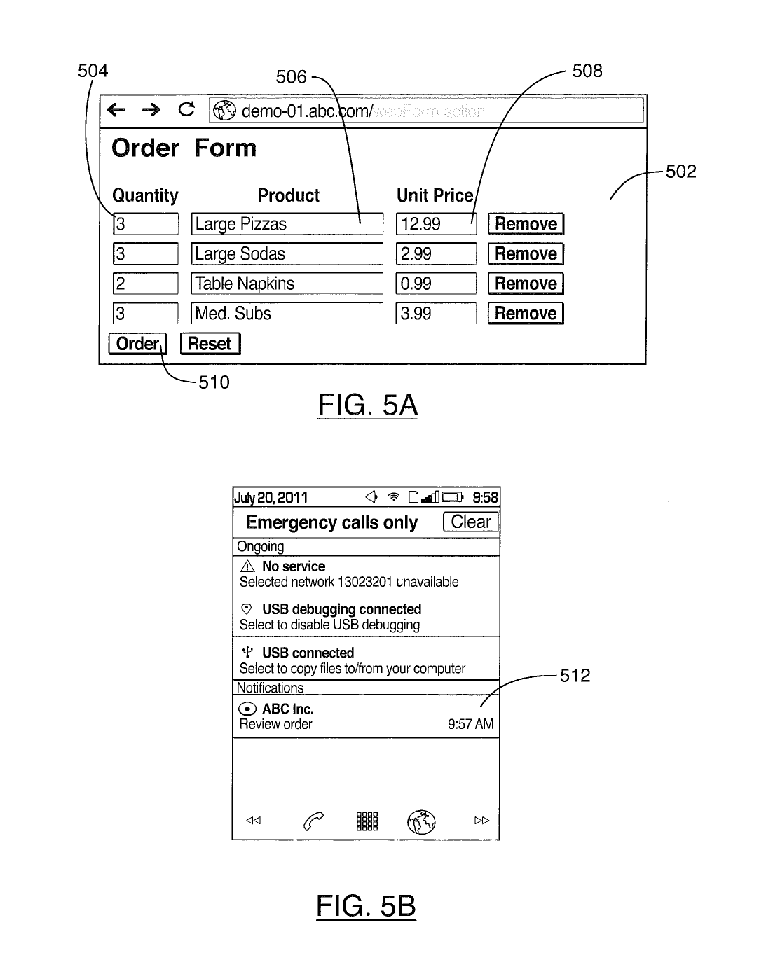

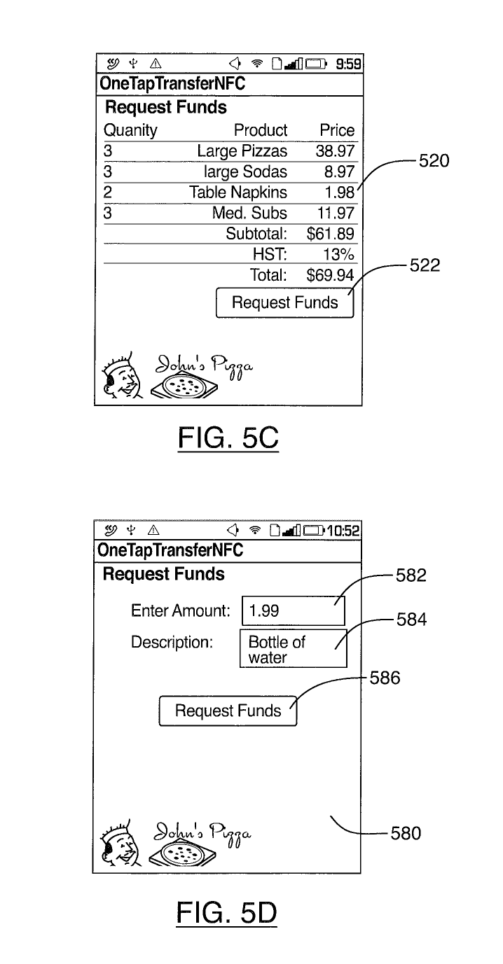

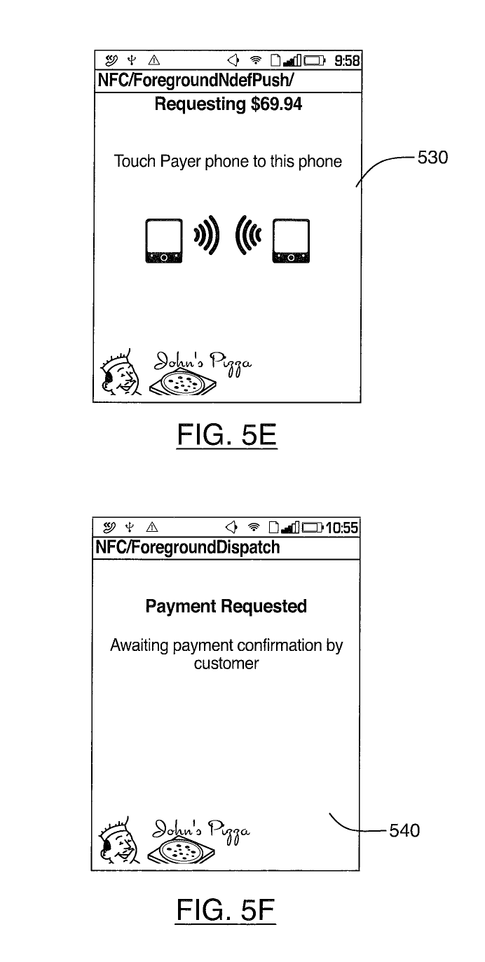

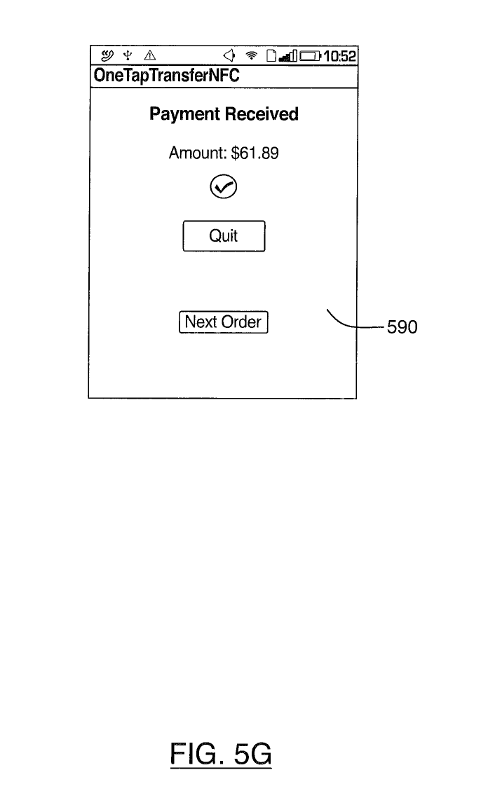

Referring now to FIGS. 5A to 5G, there are shown exemplary embodiments of a user interface for merchant device and, optionally, merchant terminal, when performing a transaction process, such as transaction process 300.

In an exemplary transaction, customer device 140 in the exemplary embodiments belongs to “Mike” and merchant device 110 belongs to “John's Pizza”.

FIG. 5A displays an exemplary web interface order form 502 for a web-initiated transaction, comprising quantity fields 504, item description fields 506, price fields 508 and a request button 510. A merchant (e.g., John's Pizza) may enter the desired items for the current order and select request button 510 to initiate a transaction.

FIG. 5B illustrates an exemplary push notification 512 received by merchant device 110, such as a push notification that may be sent by push provider 180 in response to a web-initiated transaction. The merchant may select the push notification to review order details.

FIG. 5C illustrates an exemplary order review interface, comprising a review listing 520 and a request funds button 522. In some cases, the order review interface can be automatically opened in response to receiving or selecting push notification 512 shown in FIG. 5B. The merchant may review the order details in review listing 520 and select the request funds button 522 to continue the transaction.

Alternatively, FIG. 5D displays an exemplary request interface 580 for a mobile device-initiated transaction, comprising an amount field 582, an item description field 584 and a request button 586. A merchant may enter the item information for the current order and select request button 586 to initiate a transaction.

FIG. 5E illustrates an exemplary prompt interface 530 for use in either a web-initiated or mobile device-initiated transaction, which prompts the merchant to instruct a customer to tap a customer device 140 to merchant device 110, to initiate NFC exchange (e.g., at act 310 of process 300).

FIG. 5F illustrates an exemplary waiting interface 540, which may displayed once the NFC exchange has completed and prior to receiving confirmation from transaction server 120.

FIG. 5G illustrates a confirmation interface 590, which may be displayed upon receiving confirmation of payment at merchant device 110, for example at act 340 of process 300.

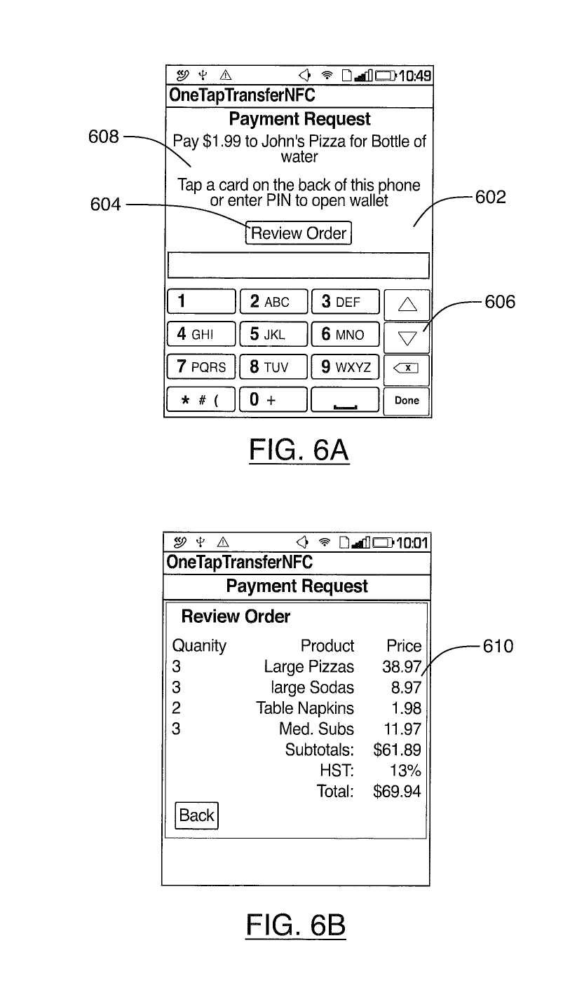

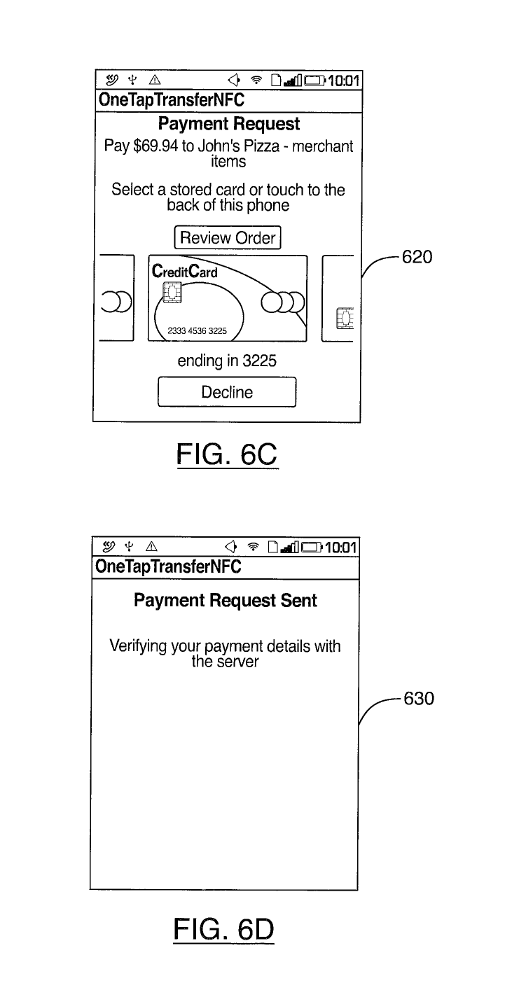

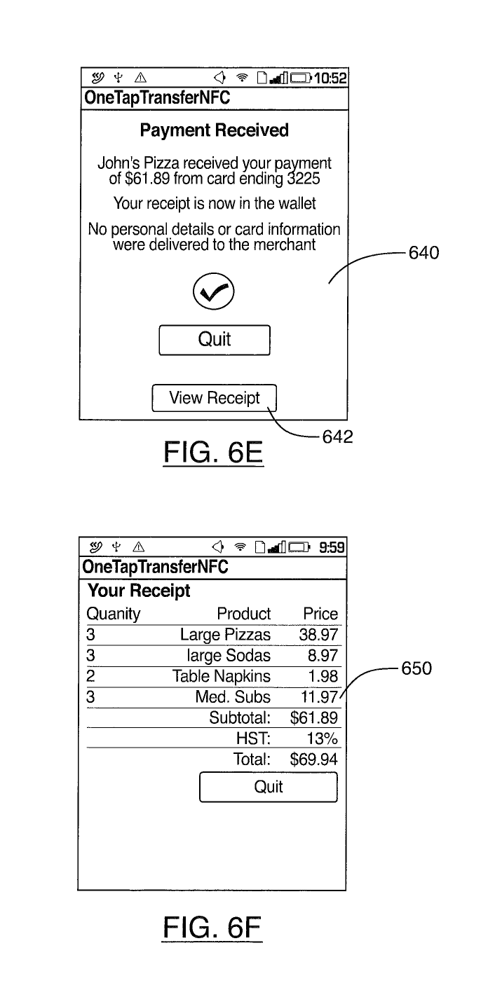

Referring now to FIGS. 6A to 6F, there are shown exemplary embodiments of a user interface for a customer device 140 when performing a transaction process, such as transaction process 300.

FIG. 6A illustrates an exemplary payment request interface 602, which may be displayed in response to an NFC exchange (e.g., at act 310 of process 300).

User interface 602 comprises a prompt message 608 instructing a customer (e.g., Mike) to select a payment method by either tapping a physical credential (e.g., credit card or fob) or using keypad interface 606 to enter a PIN for opening a digital wallet on customer device 140.

Optionally, the customer may select review order button 604 to review additional order details, as illustrated in order review interface 610 of FIG. 6B.

FIG. 6C illustrates an exemplary digital wallet interface 620 for selecting a virtual payment method, which may be displayed once a customer has provided a PIN using keypad interface 606.

FIG. 6D illustrates an exemplary customer waiting interface 630, which may displayed once the customer has selected and authenticated a desired payment method and prior to receiving confirmation from transaction server 120.

FIG. 6E illustrates an exemplary confirmation interface 640, which may be displayed upon receiving confirmation of payment at customer device 140, for example at act 350 of process 300. Confirmation interface 640 comprises a receipt button 642, which may be selected by the customer to display an order details interface

FIG. 6F illustrates an exemplary receipt interface 650, which may be displayed in response to a user selection of receipt button 642.

Referring now to FIG. 7, there is illustrated an exemplary proximity communication process using NFC for a merchant device, such as merchant device 110.

Proximity communication process for a merchant device 700 begins at 710, by writing transaction information as an NDEF record to a NFC tag. At 715, merchant device 110 waits until the NFC tag is discovered (e.g., by a customer device 140 when moved within 4 cm or less of merchant device 110) and a confirmation tag is received from customer device 140. Once the tag is discovered, merchant device 110 waits at 720 for payment confirmation from transaction server 120.

Referring now to FIG. 8, there is illustrated an exemplary proximity communication process using NFC for a customer device, such as customer device 140.

Proximity communication process for a customer device 800 begins at 810 by waiting for customer device 140 to discover the NFC tag of merchant device 110. Once the NFC tag is discovered, customer device 140 may automatically initiate further steps of process 800, beginning with validation of the NFC tag by determining whether it comprises a JSON object with valid fields, at 815.

At 820, customer device 140 generates a confirmation NDEF and NFC tag and transmits the confirmation tag to merchant device 110.

At 825, customer device 140 parses the JSON object to determine a transaction identifier and, optionally, a transaction URL.

Once the transaction identifier and transaction URL are retrieved, customer device 140 continues with a transaction process flow, such as process 300, at 830.

In some alternative embodiments, a Quick-Response (QR) code may be used in place of NFC exchange in the embodiments described above. For example, where an NFC exchange is described, a merchant device 110 may instead generate and display a QR code comprising the transaction information to be communicated, and the customer device 140, rather than reading information via radiofrequency transmission, may instead use a camera associated with customer device 140 to capture and decode the displayed QR code.

Alternatively, transactions may also be initiated using location and/or context-based information. For example, transaction server 120 may determine that two mobile devices are in the same location using GPS or Wi-Fi™ access point names. Such information may further be coupled with contextual information, such as a unique code (OTP or session code) or a user's physical movements as determined by an accelerometer of the respective mobile device (e.g., the accelerometer may be used to detect a tapping or waving motion corresponding to the transaction).

In some alternative applications, the described embodiments may be adapted for use in verifying identification of certain parties. For example, an authorized party (e.g., employer, security agent, etc.) can verify an employee's identification by requesting that the employee tap their mobile device to the authorized party's mobile device. Following a verification transaction using the methods and systems described herein, the authorized party's mobile device may display personal information about the employee (e.g., photo, employee category, department, etc.).

Similarly, an age verification may also be performed in analogous fashion. For example, in circumstances where a person's age must be verified to proceed with an action or transaction, an age verification transaction may be performed using the methods and systems described herein.

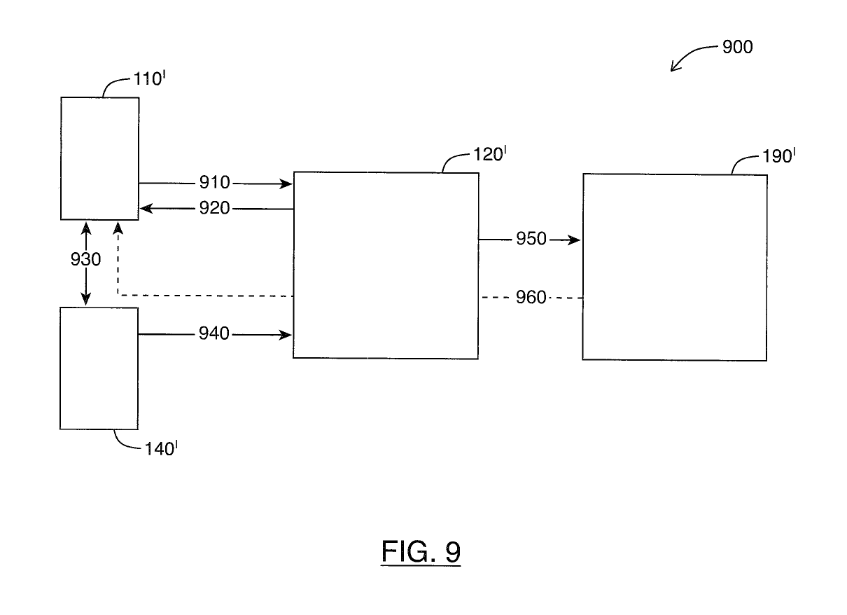

Referring now to FIG. 9, there is shown an exemplary simplified process flow for a credential verification transaction.

Credential verification transaction process 900 begins at 910, with a first device 110′ (which may be analogous to merchant device 110) instantiating a request with a transaction server 120′ (which may be analogous to transaction server 120). In some embodiments, first device 110′ may be registered with transaction server 120′, in similar manner to the registration of merchant device 110 with transaction server 120.

At 920, transaction server 120′ generates a transaction identifier and transmits the transaction identifier to first device 110′ to establish a verification transaction session between first device 110′ and transaction server 120′.

At 930, first device 110′ may generate a user interface prompt for a challenged party to tap a second device 140′ on first device 110′. Second device 140′ may be generally analogous to customer device 140. Accordingly, a NFC exchange is initiated and first device 110′ transmits the transaction identifier to second device 140′.

At 940, second device 140′ optionally displays the credential data that is to be verified to a user of the second device and, if the user chooses to continue with the verification (e.g., by pressing a confirmation button), transmits an authorization associated with the transaction identifier to transaction server 120′. Customer device 140 may also transmit additional data to help authenticate the user (e.g., a cryptogram or OTP generated on the device, an embedded card, or a card tapped on the reader). Likewise, merchant device 110 may also transmit similar data when connecting to transaction server 120.

At 950, transaction server 120′ transmits the transaction identifier to a credential provider 190′, which may be analogous to issuer 190.

At 960, credential provider 190′ transmits the requested credential data to first device 110′ via transaction server 120′. Alternatively, credential provider 190′ may instead transmit an indication that the requested credential data is valid, or meets pre-specified criteria (e.g., minimum age, etc.).

In some embodiments, a first device 110′ may have different security levels associated with it, for example at the time of registration. For example, a first security level may enable first device 110′ to verify an employee photo, organization and department name, and employment status. A second security level may enable first device 110′ to verify the same data as the first security level in addition to an employee name. A third security level may enable first device 110′ to verify the same data as the first and second security levels, in addition to an employee identification number.

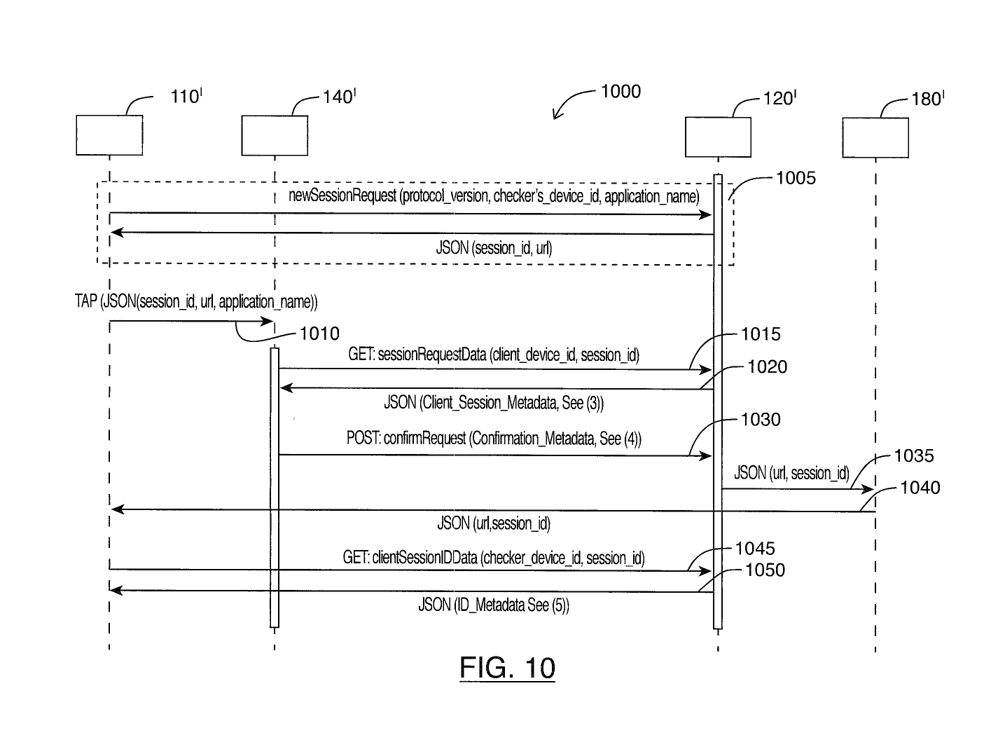

Referring now to FIG. 10, there is shown an exemplary message flow for the verification transaction process of FIG. 9. Message flow 1000 may be generally analogous to message flow 300 or 400.

Message flow 1000 begins at 1005, with first device 110′ transmitting a newSessionRequest message to transaction server 120′, which may comprise a protocol version, device identifier and application name.

Transaction server 120′ responds to the newSessionRequest message by generating and transmitting a session or transaction identifier and a transaction URL. In some embodiments, responses from transaction server 120, such as the response to the newSessionRequest message, may be transmitted using a data interchange format, such as JavaScript Object Notation (JSON). Optionally, the exchanged data structures (e.g., JSON) may be signed to enhance security, using, for example, a JSON signing technology such as JWS (JSON Web Signature).

At 1010, a second device 140′ and first device 110′ activate a NFC exchange, for example by tapping one device to the other. First device 110′ transmits transaction information to second device 140′. Transaction information may comprise a transaction identifier, application name and a transaction URL.

In some embodiments, first device 110′ creates a JSON object comprising the transaction identifier and transaction URL and writes it as a NFC Data Exchange Format (NDEF) record to the NFC interface (e.g., “NFC Tag”) in first device 110′.

Accordingly, when second device 140′ is within range (e.g., less than 4 cm away) or tapped to first device 110′, a verification module may be automatically initiated. For example, on an Android™ device, verification may be initiated by using the NFC Tag and “NDEF Discovered Intent” filter provided by the second device 140′ (e.g., Android service).

The verification module can ensure that the received data is in the required JSON format and can parse the JSON data to obtain the transaction identifier and transaction URL.

At 1015, second device 140′ transmits an HTTP GET request to transaction server 120′. The HTTP POST request may be directed to the transaction URL received from first device 110′, and may comprise information such as the unique identifier associated with second device 140′ (e.g., obtained during registration) and the transaction identifier received from first device 110′. In some embodiments, the HTTP GET request sent to transaction server 120′ may be sent as a JSON object.

Transaction server 120′ responds to the GET request at 1020 by transmitting transaction session metadata to second device 140′.

Subsequently, the user is prompted to confirm the transaction session metadata and the verification transaction. If confirmed by the user, a confirmRequest message can be sent in an HTTP POST request to transaction server 120′ at 1030.

Upon completing the verification transaction, transaction server 120′ generates a message for first device 110′ containing the outcome of the verification transaction and transmits the message to push provider 180 at 1035. In response, push provider 180′ generates a push notification comprising the outcome of the transaction and transmits the outcome message to first device 110′ at 1040.

In some alternate embodiments (not shown), the credit card data collected by customer device 140, either from a physical tap or from a pre-stored virtual card, may be sent directly to the credit card issuer via a secure channel. The issuer may then verify the payment details and transmit push messages (via push provider 180) directly to merchant device 110 and customer device 140 with the status of the payment transaction and a message.

Optionally, first device 110′ may request additional session metadata from transaction server 120′ at 1045, which may be transmitted at 1050.

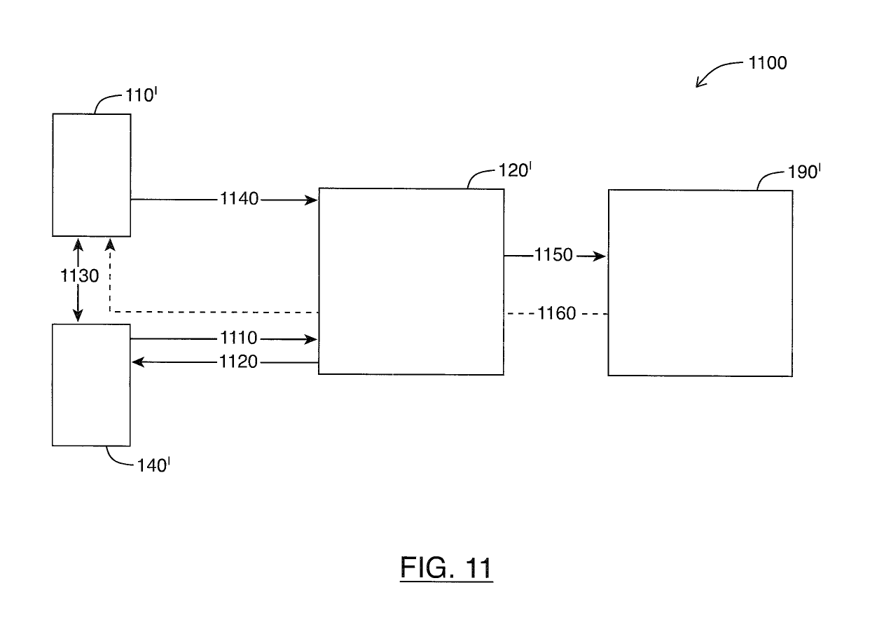

Referring now to FIG. 11 there is shown a further exemplary simplified process flow for a credential verification transaction.

Credential verification transaction process 1100 begins at 1110, with a second device 140′ (which may be analogous to customer device 140) selecting a credential to be used (e.g., employee ID, driver's license, etc.) and instantiating a request with a transaction server 120′ (which may be analogous to transaction server 120). In some embodiments, second device 140′ may be registered with transaction server 120′, in similar manner to the registration of customer device 140 with transaction server 120.

At 1120, transaction server 120′ generates a transaction identifier and transaction URL, and transmits the transaction identifier and URL to second device 140′ to establish a verification transaction session between second device 140′ and transaction server 120′.

At 1130, first device 110′ may generate a user interface prompt for a challenged party to tap a second device 140′ on first device 110′. First device 110′ may be generally analogous to merchant device 110. Accordingly, a NFC exchange is initiated and second device 140′ transmits the transaction identifier and transaction URL to first device 110′.

At 1140, first device 110′ transmits the transaction identifier to transaction server 120′.

At 1150, transaction server 120′ transmits the transaction identifier to a credential provider 190′, which may be analogous to issuer 190.

At 1160, credential provider 190′ transmits the requested credential data to first device 110′ via transaction server 120′. Alternatively, credential provider 190′ may instead transmit an indication that the requested credential data is valid, or meets pre-specified criteria (e.g., minimum age, etc.).

In some embodiments, a first device 110′ may have different security levels associated with it, for example at the time of registration. For example, a first security level may enable first device 110′ to verify an employee photo, organization and department name, and employment status. A second security level may enable first device 110′ to verify the same data as the first security level in addition to an employee name. A third security level may enable first device 110′ to verify the same data as the first and second security levels, in addition to an employee identification number.

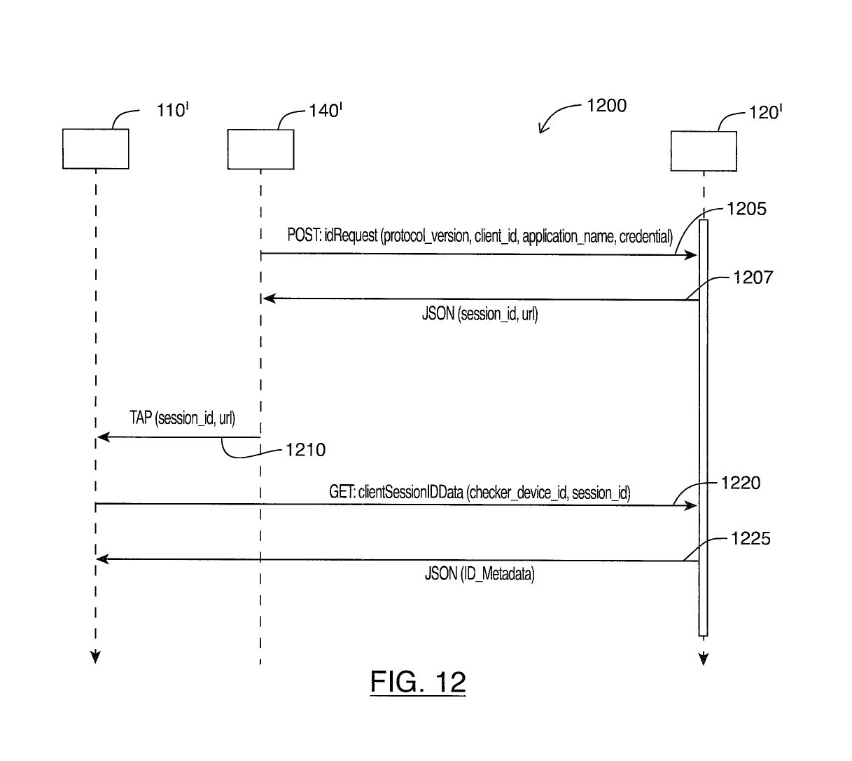

Referring now to FIG. 12, there is shown an exemplary message flow for the verification transaction process of FIG. 11.

Message flow 1200 begins at 1205, with second device 140′ transmitting an idRequest message to transaction server 120′, which may comprise a protocol version, device identifier, credential identifier and application name.

At 1207, transaction server 120′ responds to the idRequest message by generating and transmitting a session or transaction identifier and a transaction URL. In some embodiments, responses from transaction server 120, such as the response to the idRequest message, may be transmitted using a data interchange format, such as JavaScript Object Notation (JSON).

At 1210, a second device 140′ and first device 110′ activate a NFC exchange, for example by tapping one device to the other. Second device 140′ transmits transaction information to first device 110′. Transaction information may comprise a transaction identifier and a transaction URL.

In some embodiments, second device 140′ creates a JSON object comprising the transaction identifier and transaction URL and writes it as a NFC Data Exchange Format (NDEF) record to the NFC interface (e.g., “NFC Tag”) in second device 140′.

Accordingly, when second device 140′ is within range (e.g., less than 4 cm away) or tapped to first device 110′, a verification module may be automatically initiated by first device 110′. For example, on an Android™ device, verification may be initiated by using the NFC Tag and “NDEF Discovered Intent” filter provided by the first device 110′ (e.g., Android service).

The verification module can ensure that the received data is in the required JSON format and can parse the JSON data to obtain the transaction identifier and transaction URL.

At 1220, first device 110′ transmits an HTTP GET request to transaction server 120′. The HTTP POST request may be directed to the transaction URL received from second device 140′, and may comprise information such as the unique identifier associated with first device 110′ (e.g., obtained during registration) and the transaction identifier received from second device 140′. In some embodiments, the HTTP GET request sent to transaction server 120′ may be sent as a JSON object.

Transaction server 120′ responds to the GET request at 1225 by transmitting transaction session metadata (which may comprise confirmation of the identification) to first device 110′.

Although reference has been made to communication using push notification services, other forms of bi-directional communication, such as WebSocket may also be used.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments, but rather as merely describing the implementation of these various embodiments.

It will be appreciated that various embodiments may comprise one or more special purpose or general purpose computers or servers, each of which may include, but are not limited to, one or more processors, memories, storage devices, input/output devices and network interfaces. Likewise, the terms ‘computer’ and ‘server’ may be interchangeable in accordance with the above description. Furthermore, embodiments may be implemented as computer software instructions stored on a non-transitory computer readable medium and executed in memory by processors on one or more of the computers or servers contemplated above. Although embodiments have been described as separate components, it will be understood that various components could be combined into a single computer or server, or implemented across multiple computers or servers all connected via a communications medium such as the Internet.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein.

1. A method of enabling a transaction between a merchant device and a customer device, the method comprising:
a) receiving a transaction initiation request at a transaction server;
b) generating a transaction identifier and transmitting the transaction identifier to the merchant device;
c) receiving the transaction identifier from the customer device, wherein the transaction identifier has been exchanged via proximity communication with the merchant device;
d) transmitting transaction detail data to the customer device;
e) receiving a transaction authorization from the customer device; and
f) in response to the transaction authorization, completing the transaction.

2. The method of claim 1, wherein the proximity communication comprises near-field communication.

3. The method of claim 1, wherein the proximity communication comprises use of a QR code.

4. The method of claim 1, wherein the transaction identifier is transmitted to the merchant device in a push notification.

5. The method of claim 1, wherein the at least one transaction item is transmitted to the customer device in a push notification.

6. A transaction server for enabling a transaction between a merchant device and a customer device, the transaction server comprising:
a) a network interface;
b) a memory; and
c) a processor, the processor configured to:
receive a transaction initiation request;
generate a transaction identifier and transmit the transaction identifier to the merchant device;
receive the transaction identifier from the customer device, wherein the transaction identifier has been exchanged via proximity communication with the merchant device;
transmit transaction detail data to the customer device;
receive a transaction authorization from the customer device; and
in response to the transaction authorization, complete the transaction.

7. The transaction server of claim 6, wherein the proximity communication comprises near-field communication.

8. The transaction server of claim 6, wherein the proximity communication comprises use of a QR code.

9. The transaction server of claim 6, wherein the transaction identifier is transmitted to the merchant device in a push notification.

10. The transaction server of claim 6, wherein the at least one transaction item is transmitted to the customer device in a push notification.

11. A system for enabling a transaction, the system comprising:
a) a transaction server configured to:
i) receive a transaction initiation request;
ii) generate a transaction identifier;
b) a merchant device configured to:
i) receive the transaction identifier;
ii) activate a proximity communication interface to transmit the transaction identifier;
c) a customer device configured to:
i) receive the transaction identifier via the proximity communication interface;
ii) transmit the transaction identifier to the transaction server;
iii) receive transaction detail data from the transaction server, wherein the transaction detail data is transmitted by the transaction server in response to receiving the transaction identifier from the customer device;
iv) request a transaction authorization from a user of the customer device; and
v) in response to receiving the transaction authorization, transmit the transaction authorization to the transaction server to enable the transaction server to complete the transaction.

12. The system of claim 11, wherein the proximity communication comprises near-field communication.

13. The system of claim 11, wherein the proximity communication comprises use of a QR code.

14. The system of claim 11, wherein the transaction identifier is received by the merchant device in a push notification.

15. The system of claim 11, wherein the at least one transaction item is received by the customer device in a push notification.
